(19) United States
(12) Patent Application Publication
(10) Pub. No.: US 2024/0239039 A1
(43) Pub. Date: Jul. 18, 2024

(54) HIGH RESOLUTION AND THREE-DIMENSIONAL PRINTING IN COMPLEX PHOTOSENSITIVE MATERIALS

(71) Applicant: ECOLE POLYTECHNIQUE FEDERALE DE LAUSANNE (EPFL), Lausanne (CH)

(72) Inventors: Christophe MOSER, Lausanne (CH); Antoine BONIFACE, Romont (CH); Jorge MADRID-WOLFF, Prilly (CH)

(73) Assignee: ECOLE POLYTECHNIQUE FEDERALE DE LAUSANNE (EPFL), Lausanne (CH)

(21) Appl. No.: 18/561,433

(22) PCT Filed: May 17, 2022
(86) PCT No.: PCT/EP2022/063245

§ 371 Date: Nov. 16, 2023

(30) Foreign Application Priority Data
May 17, 2021 (EP) 21174082.4

(51) Int. Cl. B29C 64/129; B29C 64/232; B29C 64/241; B29C 64/255; B29C 64/264; B33Y 10/00; B33Y 30/00

(52) U.S. Cl. CPC B29C 64/129; B29C 64/232; B29C 64/241; B29C 64/255; B29C 64/264; B33Y 10/00; B33Y 30/00

(57) ABSTRACT

A method of volumetric manufacturing a three-dimensional object or article by illuminating a non-transparent and/or absorptive photosensitive material with light patterns from multiple angles. The method including the steps of capturing at least one fluorescence or scattering snapshot for one or a set of different illuminating projected patterns in the said photo-sensitive material, obtaining therefrom at least one physical parameter describing the light propagation through the photosensitive material, and computing a set of optimized projected patterns with the aid of the at least one physical parameter. The optimized projected patterns are used for volumetric manufacturing the three-dimensional object or article. A device for performing the method is further described.

### FIELD OF THE INVENTION

The present invention relates to a method and an apparatus for the volumetric fabrication of three-dimensional objects or articles from photo-responsive materials.

In particular, the present invention is related to:
volumetric manufacturing of a three-dimensional object or article with light patterns that are projected in a non-transparent photo-sensitive resin by first characterizing the scattering of light by said resin and then optimizing the projected light patterns in order to improve the print fidelity;
printing relatively large size structures with no sacrifice in spatial resolution by modifying the configuration of the setup used in conventional tomographic approaches;
fabricating systems yielding high resolution and large-scale parts by combining single photon volumetric tomographic, and multi-photon polymerization (via a non-linear absorption of light), in photo responsive materials.

### BACKGROUND

Until only a few years ago, the conventional approach in three-dimensional printing (also referred to as 3D printing) or additive manufacturing relied on adding material layer-by-layer. This fabrication process is based on a sequential operation which consists of constructing the 3D object by piling two dimensional layers on top of each other. An example is stereolithography (SLA) (see for example U.S. Pat. No. 5,344,298), where the object is formed one layer at a time by the solidification of a photocurable resist under light irradiation before application of a subsequent layer. The successive layers of the object can be defined for example by scanning a laser beam point-by-point, as suggested in U.S. Pat. No. 5,344,29, or by digital light processing (DLP) technology, as described in U.S. Pat. No. 6,500,378. This sets some limitations on the applications and geometries for which this technique is suitable, such as printing onto a substrate or around a pre-existing structure.

Recently, a completely new light-based strategy for 3D printing with promising perspectives was proposed (Volumetric additive manufacturing via tomographic reconstruction, Science 363, 6431 (2019); and High-resolution tomographic volumetric additive manufacturing, Nature communications 11, 1 (2020)). The idea, as described in WO-2019/043529 A1 and U.S. Pat. No. 10,647,061, consists of irradiating a volume of transparent and photo-responsive material with computed two-dimensional light patterns from multiple angles. The light exposure results in a volumetric energy dose which is sufficient to solidify the material in the desired geometry. The main advantages of this method compared to existing methods are its very rapid manufacturing time (down to a few tens of seconds), and its ability to print complex hollow structures without the need for support structures as required in layer-by-layer manufacturing systems. To achieve a correct three-dimensional light dose deposition in the build volume, the light patterns projected from multiple angles must illuminate the entire build volume. This restricts the printing technique to transparent materials (i.e. no scattering of light) and with as little absorbance as possible, which sets, in particular, an upper limit on the photo-initiator concentration in the material to be exposed to the light patterns.

The tomographic-based methods are called volumetric because they depart from the layered fabrication to construct the object in a true three-dimensional fashion. The build volume is determined by the cross section of the projected patterns (x, y) and the diameter of the resin container (z) in which the material to be exposed is provided. Objects with scale of the order of 2 cm×2 cm×2 cm with resolution of 80 micrometers have been demonstrably prepared. A 4 cm³ 3D object was built in 23 seconds, which corresponds to a throughput of 626 cm³/h (Volumetric Bioprinting of Complex Living-Tissue Constructs within Seconds, Adv Mater 31, 1970302 (2019)). As one could see in this work, the final resolution of the printing structure is determined by the effective pixel size of the projected images at the center of the build volume. A number of effects, such as the diffusion of chemical species or the optical aberrations inherent to the setup, can drastically decrease the resolution of volumetric printing methods. However, they are most of the time neglected and simply not taken into account during the computation of the light patterns.

One challenging task in volumetric tomographic printing is to determine the required light patterns from the desired dose distributions. An interesting aspect of this two-dimensional inverse problem is its close relationship to computed tomography, widely used in medical imaging, that aims at reconstructing a three-dimensional image from its projections. Under some simplifying assumptions, these two problems—CT imaging and 3D printing—are in fact mathematically identical. It results that the same algorithm as developed for CT can be successfully applied to volumetric printing. In the present case, the light patterns are calculated using a filtered back-projection algorithm. First, 3D models in STL format are converted to a three-dimensional voxel binary map (hereinafter designated as binary object), that is to say a 3D array where the values “1” indicate the presence of the object and “0” its absence at each particular location in space. For each 2D section of this 3D matrix, projections are calculated over a 360° grid of angles, using the Radon transform. The projections are subsequently filtered with a Ram-Lak filter in the Fourier domain. This filter yields a set of projections which, when projected back into an empty volume, results in theory in a perfect reconstruction of the object. In practice, the Ram-Lak filter produces projections with patterns whose values can be positive or negative, the latter of which cannot physically be projected into the volume. For this, a simple threshold is typically used to set the negative values to 0. While this makes the resulting reconstruction approximate instead of exact, it was observed that most of the light dose is still concentrated in the shape of the object. Only these parts of the volume solidify because of the gelation threshold of the photopolymer (photo-responsive material), i.e. the threshold value of required light dose necessary to cause a phase transfer of liquid photo-responsive material into a solid (gellified) material. While other parts of the photo-responsive material do receive a certain amount of unwanted light dose, this is not enough to surpass the gelation threshold in the majority of cases.

Moreover, the Radon transform supposes that patterns propagate in a straight line without being attenuated or distorted. This assumption is no longer valid when printing in non-transparent materials. In this case, refractive index inhomogeneities in the resin scatter light and distort patterns; which compromises printing resolution. There is a need for a new method for computing the projection patterns that take into account the scattering properties of non-transparent media. There is also a need for printing relatively large size structures with no sacrifice in spatial resolution.

### SUMMARY OF THE INVENTION

The present invention is related to new strategies and detailed protocols to increase tomographic printer capabilities. It includes:
According to a first embodiment of the present invention, a method comprising a 3-step protocol to account for light scattering is disclosed in order to print in non-transparent and/or absorptive materials, preferably resins, gels, or hydrogels for bioprinting applications. Said first embodiment also is related to a system extracting quantitative information of the resin's scattering. Said system comprises a side view camera, which captures fluorescence or linear scattering snapshots (step 1) for one or a set of different illuminating projected patterns in the said non transparent and absorptive resin. Patterns can be produced from a light source and a light modulator. These experimental measurements can preferably be performed on the same setup used for 3D printing. However, it is also possible to perform these experimental measurements on a different experimental setup. The camera setup of step 1 provides an estimate of multiple physical parameters (step 2) at different depths of said resin that gives quantitative parameters describing the light propagation through the said scattering resin. Finally, a new forward model that takes into account the experimentally-measured parameters and a model of the print is used to compute (step 3) the set of optimized patterns to project in the resin bath that improves print fidelity and resolution.
Accordingly, the present invention is related to a method of volumetric manufacturing a three-dimensional object or article by illuminating a non-transparent and/or absorptive photo-sensitive material with light patterns from multiple angles, comprising the steps:
a) capturing at least one fluorescence or scattering snapshot for one or a set of different illuminating projected patterns in the said photo-sensitive material,
b) obtaining from said at least one snapshot at least one physical parameter describing the light propagation through the said photo-sensitive material,
c) computing a set of optimized projected patterns with the aid of the parameter(s) obtained in step b), wherein said optimized projected patterns are used for volumetric manufacturing said three-dimensional object or article.
The present invention is furthermore related to a device for performing the method described above, said device comprising a light source, a light modulator, preferably a spatial light modulator such as a DMD, a container for non-transparent and/or absorptive photo-sensitive material, and a side-view camera, preferably positioned orthogonally to the optical path of the light patterns projected by said light modulator.
According to a second embodiment of the present invention, an optical setup is used to increase the volumetric printing resolution in which a light source illuminates a digital projector or light modulator which is positioned off-center from the vessel containing the photopolymer, so as to illuminate approximately half of the vessel. This method can increase the lateral build dimension or the 3D print size by a factor 2 while maintaining the lateral resolution.
According to a third embodiment of the present invention, a transport device such as a linear stage is implemented to move said vessel of transparent or non-transparent resin up and down with respect to the projector or light modulator to print taller objects. This embodiment is inspired by spiral/helical computed tomography, widely used in medical spiral/helical imaging, for example for scanning the whole human body. It has, however, not been implemented for volumetric printing. A rotator allows to project light from multiple angles. Light from a second light source is sent approximately orthogonally to the direction of the printing light in order to monitor the state of the print in the vessel with a camera.
Accordingly, the present invention is furthermore related to a method of volumetric manufacturing a three-dimensional object or article by illuminating a photo-sensitive material with light patterns from multiple angles, comprising the step of projecting said light patterns onto the photo-sensitive material with a light modulator, preferably a spatial light modulator such as a Digital Micromirror Device (DMD), that is positioned off-center from a container containing said photo-sensitive material.
The present invention is furthermore related to a device for performing the method described above, said device comprising a light source, a light modulator, preferably a spatial light modulator such as a DMD, a container for photo-sensitive material, wherein said light modulator is positioned off-center from a container containing said photo-sensitive material.
According to a fourth embodiment of the present invention, to further increase the print resolution a new method and apparatus is disclosed for a volumetric manufacturing system yielding large scale and high-resolution parts by combining single photon volumetric printing by reverse tomography and non-linear absorption processes, such as but not limited, to two photon polymerization. A first step of said embodiment comprises delivering a 3D light dose into the main body of the photo-responsive material of the desired print with said single photon volumetric printing. The 3D light dose delivered in this first step is below the gelation threshold of the photo-responsive material. This first step exhibits high efficiency and high speed. Subsequently, in a second step the resin is illuminated with a focused laser beam at longer wavelength, such as in the near infrared range of the electromagnetic spectrum, that is absorbed, via a multi-photon process, such as a two photon process. The light in the multi-photon process can be absorbed by so-called two photon photoinitiators which create radicals that promote photopolymerization. The two or multi photon absorption process can also be implemented via nanoparticles or colorants which convert near infrared photons into ultra violet, or visible (for example blue) photons, preferably in the range of 320 to 450 nm. This latter secondary emission is then absorbed by single photon photoinitiators to promote photopolymerization. This offers the possibility to
a) locally overprint, i.e. deliver a light dose sufficient to cross the gelation threshold to obtain high resolution features (micron scale) in the main structure. To obtain the maximal resolution, it is preferably to be ensured that the focal spot is diffraction-limited using wavefront-shaping techniques exploiting the fluorescence from the particles as signal for a closed-loop feedback.
b) alternatively pre-excite the photopolymer homogenously in the volume via a one photon absorption photoinitiator for an exposure close to the gelation threshold, and to overpass the gelation threshold locally by means of the longer wavelengths. By moving the focused beam across the print, a large scale and high resolved print can be obtained in a relatively fast manner.

Accordingly, the present invention is furthermore related to a method of volumetric manufacturing a three-dimensional object or article by illuminating a sample part with light patterns from multiple angles, comprising
a first step of projecting said light patterns onto the sample part with a light modulator, preferably a spatial light modulator such as a Digital Micromirror Device (DMD), wherein a light dose delivered in this first step is below the gelation threshold of a resin provided in the sample part,
a second step of projecting light patterns onto the sample part with a light modulator, preferably a spatial light modulator such as a Digital Micromirror Device (DMD), wherein said light patterns of said second step have a longer wavelength than said light patterns used in the first step.

The present invention is furthermore related to a device for performing the method described above, said device comprising a first light source, a second light source emitting light of a longer wavelength than the first light source, a first light modulator, preferably a spatial light modulator such as a DMD, for projecting light patterns from said first light source, a second light modulator, preferably a spatial light modulator such as a DMD, for projecting light patterns from said second light source and a sample part for photo-sensitive material.

### BRIEF DESCRIPTION OF THE DRAWINGS

The invention is described hereinafter in detail with non-limiting preferred embodiments and non-limiting drawings, wherein,

FIG. 1 is a scheme of principle representing a 3-step protocol according to the first embodiment of the present invention that can be used to print in scattering and absorptive photo-sensitive resins. In detail,

FIG. 1A is an example of the characterization of light scattering according to said first embodiment of the present invention.

FIG. 1B is an example of the computation of corrected patterns from experimentally-fitted parameters according to said first embodiment of the present invention, and

FIG. 1C is an example of a print on an experimental setup according to said first embodiment of the present invention that enables to quantify the correction-induced improvement.

FIG. 2 shows a set of three photographic pictures of an example according to the present invention. In detail,

FIG. 2A shows the effect of scattering in an example of a scattering resin under illumination with white light.

FIG. 2B a schematic view of the setup used for characterization of scattering

FIG. 2C shows the effect of scattering of said resin under illumination with UV light, in a perspective view and a side view.

FIG. 3 comprising FIGS. 3A-3F presents an embodiment of a forward model according to the present invention that corrects for the attenuation in real space. In detail,

FIG. 3A shows how the propagation of light through the resin is affected by scattering.

FIG. 3B shows the experimental data obtained from FIG. 3a, and their fitting.

FIG. 3C shows the reconstructed two-dimensional profile of ballistic light across the vial.

FIG. 3D shows the binary object before applying a correction mask.

FIG. 3E shows a correction mask obtained from the two-dimensional profile of FIG. 3c, and

FIG. 3F shows the binary object after applying the correction mask.

FIG. 4 comprising FIGS. 4A-4M presents the forward model that corrects for the attenuation in spatial frequency space. In detail,

FIG. 4A shows blurring of a light pattern protruding through a photosensitive resin in a side-view picture

FIG. 4B shows a computed one-dimensional Fourier transform of the light pattern of FIG. 4A in y direction

FIG. 4C shows a sum over different one-dimensional Fourier transforms of FIG. 4B

FIG. 4D shows a correction mask that has been computed based on the results shown in FIGS. 4A-C FIG. 4E shows blurring of a light pattern protruding through a photosensitive resin as reflected in different z-profiles thereof

FIG. 4F shows corresponding profiles of the one-dimensional Fourier transform of FIG. 4B at different depths

FIG. 4G shows a sum over different one-dimensional Fourier transforms of FIG. 4C for different z values

FIG. 4H shows different correction mask profiles for different z values

FIG. 4I shows an example of a target binary object

FIG. 4K shows an example of a 2D mask obtained by applying an axial symmetry with respect to the central frequency k_{y}=0 mm⁻¹

FIG. 4L shows the result of the depth-dependent application of a correction mask in real space

FIG. 4M shows the sum of the annular dose distributions to be projected onto the resin.

FIG. 5 is an example of a detailed annotated workflow of the correction algorithm according to the present invention used to compute the “scattering-corrected” light patterns. In detail,

FIG. 5A shows a schematic view of the setup used for characterization of scattering, which is identical to the set-up of FIG. 2B

FIG. 5B shows the effect of scattering of said resin under illumination with UV light, in a perspective view and a side view

FIG. 5C shows the determined optical properties of the non-transparent resin (attenuation of ballistic light, blur of the pattern with depth, etc.) in a side view picture of light scattering

FIG. 5D shows a frequency attenuation obtained by a 1D Fourier transformation of the side view profile of FIG. 5C

FIG. 5E shows a correction mask retrieved from the 1D Fourier transformation of FIG. 5D

FIG. 5F shows a target 3D model that is subjected to binarization, and subsequently subjected to a frequency boost with the aid of a corrected dose determined using the correction mask of FIG. 5E, wherein the computation of a correction mask enables to estimate the light dose to project in order to limit the degradation of the print due to scattering. The latter is used to calculate a sinogram and find desired projected patterns.

FIG. 6 shows a simplified workflow of an example of a suitable algorithm according to the present invention. In detail,

FIG. 6A shows a target 3D model

FIG. 6B shows the binarized target 3D model applying a conventional dose

FIG. 6C shows the target light dose (here 2D, for sake of simplicity) obtained by correction with the method of FIG. 5

FIG. 6D shows a sinogram obtained by performing a Radon transform on the target light dose of FIG. 6C, and the sinograms resulting from performing subsequently a filtration, a posititiy constraint and an optimization step.

FIG. 6E shows the projected doses derived from back-projections of the various sinograms of FIG. 6D.

FIG. 7 is a visualization of results obtained with the method according to the first embodiment. In detail,

FIG. 7A shows a target 3D model and exemplary transparent (left) and scattering (right) resins

FIG. 7B shows photographs and micro CT models of the target model of FIG. 7A obtained in a transparent resin, in a scattering resin using conventional tomographic VAM, and a scattering resin using tomographic VAM with the scattering correction of the present invention.

FIG. 7C shows a comparison of the print fidelity obtained in a transparent resin using conventional tomographic VAM, in a scattering resin using conventional tomographic VAM, and in a scattering resin using tomographic VAM with the scattering correction of the present invention.

FIG. 7D shows photographs and micro CT models of a true 3D model obtained in a transparent resin, in a scattering resin using conventional tomographic VAM, and a scattering resin using tomographic VAM with the scattering correction of the present invention.

FIGS. 8 and 9 show the results when the scattering correction of the present invention is applied to a hydrogel loaded with living cells. In detail,

FIG. 8A shows a 3D model comprising hollow channels

FIG. 8B shows a visualization of high scattering of cell-laden hydrogels with a white lamp and in FIG. 9B with a structured blue light pattern

FIG. 8C shows the resulting 3D dose in conventional VAM and scattering-corrected VAM

FIG. 8D shows the obtained uncorrected and corrected printed objects

FIG. 9A shows a 3D model comprising hollow channels

FIG. 9B shows a visualization of high scattering of cell-laden hydrogels with a structured blue light pattern

FIG. 9C shows 2D light patterns corresponding to the light doses of FIG. 8C

FIG. 9D shows the obtained uncorrected and corrected printed objects

FIG. 9E shows a a cm-scale construct with all four channels unclogged and a solid core in a soft hydrogel loaded with 4 million HEK 293 cells mL⁻¹ produced with scattering corrected tomographic VAM according to the present invention.

FIG. 10 shows a comparison of the printing fidelity of the method according to the present invention with the printing fidelity of conventional tomographic printers.

FIG. 11a is a top view of an embodiment of a tomographic additive manufacturing apparatus according to the present invention to print a large size object.

FIG. 11b is a side view of another embodiment of a tomographic additive manufacturing apparatus according to the present invention to print a large size object.

These embodiments in FIG. 11 have the particularity of using the digital modulator in an off-centred fashion and a translation stage to move the resin's vial up and down with respect to the modulator. These two added features enable printing objects whose lateral and vertical sizes are more than double with the same resolution (voxel size).

FIG. 12 shows a comparision of an object printed with conventional tomographic printing with an on-axis DMD and an object printed with tomographic printing according to an embodiment of the present invention with an off-center DMD.

FIG. 13 shows the effect of decreasing the divergence of the projected patterns along the optical axis.

FIG. 14 shows the effect of defocusing of the projected patterns.

FIG. 15a is a top view of an embodiment according to the present invention to combine single photon additive manufacturing by reverse tomography and non-linear absorption processes.

FIG. 15b is a schematic diagram of the steps to calibrate the phase front from fluorescent particles behind or in the sample, and to print with corrected wavefronts.

### DETAILED DESCRIPTION

In tomographic volumetric additive manufacturing (herein also designated as volumetric manufacturing), a resin container comprising photo-responsive material is illuminated with patterns of light from multiple angles. The resin (photo-responsive material) has the property to be photo-sensitive, which means here that a photo-initiator under light exposure can trigger the solidification of the material. The main advantage of this technique is the capability to rapidly print a full centimeter-scale object at once with high resolution.

An apparatus for tomographic additive manufacturing is described in detail in e.g. WO 2019/043529 A1 or US 2018/0326666 A1.

However, light may also have other unwanted interactions with the material. These are frequently overlooked as most resins are transparent and almost non-absorptive, but must be considered in the case of more complex materials. This is the case when printing in biological tissues or hydrogels or composite resin which are of utmost interest for bio printing and medical applications such as, but not limited to orthodontics, and hearing aids. The main issue is that cells and other biological components scatter light. To some extent, printing in such material is still achievable with a tomographic approach, since light penetrates inside the volume, but the print quality is drastically reduced.

According to a first embodiment of the present invention, a concept is disclosed to significantly improve the printing fidelity of tomographic volumetric additive manufacturing in scattering materials. The first embodiment of the present invention comprises characterizing the propagation of light through the photo-sensitive material, preferably resin, of interest thanks to a side-view detection, and using the most relevant experimentally measured quantitative parameters to correct the projected patterns with an algorithm described below. Several forward models are described that enable applying a correction with different degrees of complexity. It was demonstrated experimentally, with a series of different prints, that these numerical corrections performed on the projected patterns improve significantly the printability in terms of achieved resolution and replicability.

The problem of light scattering by random media is of great importance for many areas of science and technology including imaging, remote sensing and optical communications.

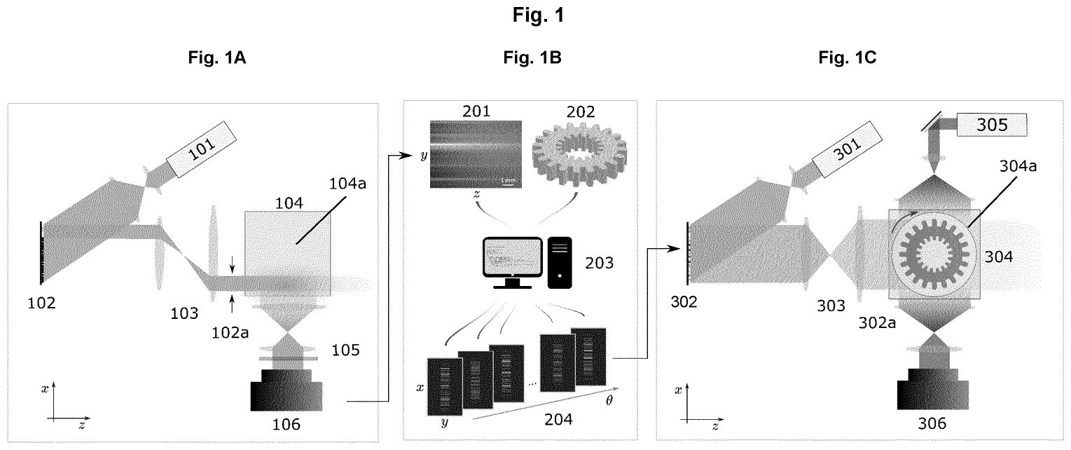

The wave disturbance caused by the inherent microscopic refractive index inhomogeneity in such media creates serious hindrance for transmitting or collecting information. In the case of tomographic (volumetric) printing, the scattering of light prevents depositing the desired light dose in precise 3D locations in the resin container. It results in severe deviations between the actually printed object and the target geometry that is aimed to be achieved. The most visible differences are mainly the presence (respectively absence) of unwanted (respectively wanted) parts and a global loss of resolution. To limit these discrepancies that distort the print, a 3-step procedure represented in FIG. 1 is proposed which includes:
the characterization of light scattering (FIG. 1A)
the computation of corrected patterns from experimentally-fitted parameters (FIG. 1B)
the print on the experimental setup that enables to quantify the correction-induced improvement (FIG. 1C)

According to the present invention, a non-transparent and/or absorptive photo-sensitive material is a material that does not allow a complete (100%) transmission of light in the visible range of the electromagnetic spectrum through a layer or body formed from said material, due to scattering and/or absorption of at least a portion of light moving through said material.

Firstly, it is determined how a specific non-transparent, scattering and/or absorptive photo-sensitive material perturbs light propagation. It is critical to understand the complex effects of multiple scattering, and hence essential for improving the performance of the printer. As sketched in FIG. 1A, this optical characterization can be performed by producing one or a set of light patterns from a light source 101, and projecting these light patterns 103 with a spatial light modulator 102 (here a DMD (Digital Micromirror Device), but any other spatial light modulator can be used) onto a container 104 such as a square cuvette containing a scattering photo-sensitive material 104a, preferably a resin. Preferably, the light patterns 103 are projected onto the container 104 through a thin sheet of light 102a. The container 104 can be immersed in a bath of index-matching liquid (not shown) to mitigate the lensing effect caused by the shape of the container 104 and allow the light patterns 103 to travel straight through the photoresponsive material 104a.

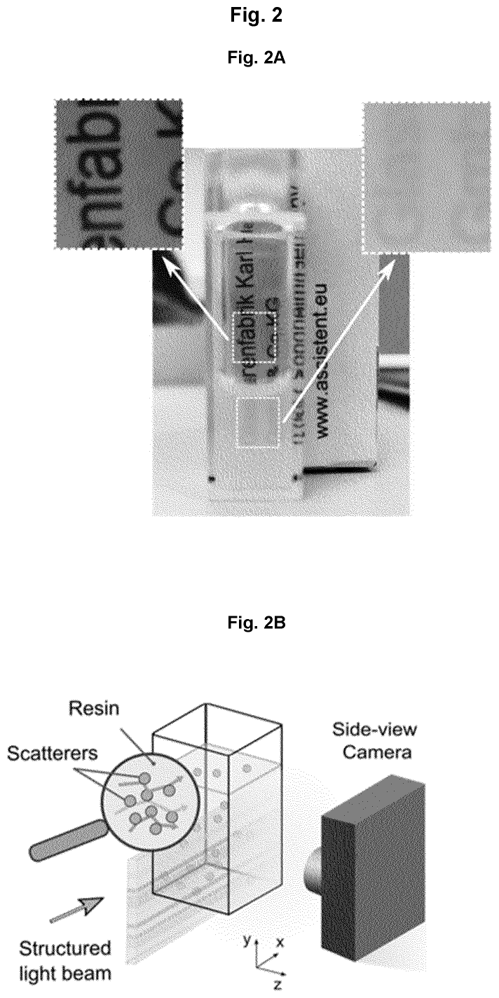

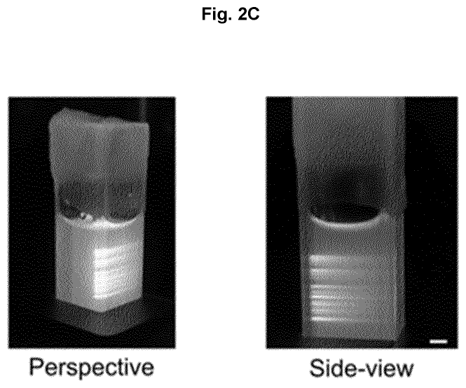

To demonstrate the method, a scattering resin is prepared with a controlled amount of scattering in the following manner: a transparent resin (for example, but not limited to, Dipentaerythritol Pentaacrylate, SR399, Sartomer Arkema) becomes a scattering resin by adding TiO₂ nanoparticles (TiO₂ nanopowder, <100 nm particle size, Sigma Aldrich) homogeneously dispersed in the resin. The concentration of TiO₂ is around 0.3 mg/mL. Although this concentration is low, the scattering induced by TiO₂ nanoparticles is so high (refractive index of TiO₂ is 2.7 at 500 nm compared to 1.5 for the monomer) that the level of scattering is deleterious for volumetric printing. This can be visualized for the naked eye, as shown in FIG. 2. Different pictures of the resin at this TiO₂ nanoparticles concentration clearly show that the obtained amount of scattering is sufficient to drastically affect light propagation. FIG. 2a shows the effect of scattering in an example of a scattering resin under illumination with white light. In FIG. 2.b, a schematic view of the characterization setup is presented. Using the modulator of the printer, one or a set of structured patterns are projected onto a square cuvette containing the scattering resin under study. A side view camera, orthogonal to the optical axis, captures the UV scattered light. FIG. 2c shows the effect of scattering of said resin under illumination with UV light, in a perspective view and a side view.

In contrast to known volumetric printing devices from the prior art, as can be seen in FIGS. 1A and 2B, according to the first embodiment of the present invention a camera 106, preferably positioned orthogonally to the optical axis (i.e. the light path of the projected patterns 103), such as a side view camera, is used to image the lateral facet of the cuvette (i.e. the container 104, side-view configuration). According to the present invention, any conventional camera capable of detecting fluorescent or scattering light can be used for this purpose. Preferably, a filter 105 is provided between the container 104 and the camera 106. If the camera is not placed orthogonally to the optical axis, a correction for the angle can be performed. Preferably, a square or rectangular cuvette is chosen as a resin container 104, but the method is not limited to this type of cuvette as correction factors can be applied (for instance correcting for the curvature in the case of cylindrical cuvettes).

The position of the square cuvette (container 104) is preferably aligned such that the light pattern 103 projected with the spatial light modulator 102, such as a DMD, falls close to its edge (as represented in FIG. 2B). The edge of the cuvette (container 104) closer to the side of the camera 106 is preferably chosen so as to minimize the scattering of light in the axis of the camera 106. The pattern chosen for the scattering characterization is deliberately narrow along the x-axis (see FIG. 1A and FIG. 2B) in order to improve the optical sectioning and increase the contrast of the image obtained with the camera 106. The latter captures only a small part of the scattered light, the one that reaches the sensor of the camera 106 positioned at 90 degrees to the optical axis. It is important to emphasize here that the amount of light falling onto the sensor of the camera 106 is intrinsically related to the angular distribution of light intensity scattered by the particles, also referred to as the phase function. In the case of TiO₂, the particles are very scattering and light is deviated almost isotropically. In contrast, other scattering materials like cells, would exhibit a strong forward scattering and the probability of photons reaching the 90-degrees positioned detector is smaller. In that situation, a fluorescent dye can be added to the resin and the corresponding isotropic fluorescence signal recorded on the camera. In this case, a filter 105 blocking the fundamental light wavelength (e.g. 400 nm) and allowing passing of the fluorescence (e.g. 600 nm) can be placed in front of the camera. The main idea remains to collect enough light with the side-view camera 106 so that a signal-to-noise ratio is reached which is sufficient to extract the information needed, more precisely to quantify how the patterns are affected by scattering.

As shown in FIG. 1B, a new forward model is established that takes into account parameters 201 experimentally-determined from the set-up described in FIG. 1A. A model 202 of the desired print is used to compute in a suitable processing unit 203, such as a conventional computer (step 3), a set of optimized patterns 204 to project into the resin bath that improves print fidelity and resolution.

As shown in FIG. 1C, a print on an experimental setup is subsequently performed that enables to quantify the correction-induced improvement achieved with the method of the first embodiment. These experimental measurements can be performed on the same setup shown in FIG. 1A used for printing or on a different experimental setup. It is preferable to have the characterization performed with the same set-up as the 3D printing. In detail, one or a set of light patterns 303 are produced from a light source 301 and projected with a spatial light modulator 302 (here a DMD (Digital Micromirror Device), but any other spatial light modulator can be used) onto a container 304 such as a square cuvette containing a scattering photo-sensitive material 304a, preferably resin. Preferably, the light patterns 303 are projected onto the container 304 through a thin sheet of light 302a. The container 304 can be immersed in a bath of index-matching liquid (not shown) to mitigate the lensing effect caused by the shape of the container 304 and allow the light patterns 303 to travel straight through the photoresponsive material 304a. The optimized patterns 204 obtained in the second step in FIG. 1B are used for modifying the operation of the spatial light modulator 302. Light from a second light source 305 positioned orthogonally to the path (optical axis) of the light patterns 303 is led through the photoresponsive material 304a and captured by a camera 306 in order to monitor the state of the print in the container 304.

Light scattering by disorder is an intricate phenomenon that is difficult to describe analytically. The exact calculation of light propagation through an opaque material is in practice impossible. It would require the knowledge of the position and size of every scatting particle in the material. A convenient way to approach this problem is to develop a transport equation from the wave equation. It implies neglecting the wave character of light, and only considering intensity of the electric field, which is a good approximation when dealing with light of low coherence, as in the case of the present invention. The transport equation describes transport of a flux of photons and takes the form of the radiative transport equation (RTE). For a unidirectional beam, the loss term in the RTE leads to an exponential decay of the specific intensity (Beer-Lambert law). This holds only for ballistic light that does not suffer scattering. Light that is scattered away from the path of ballistic light tends to broaden the angular intensity distribution.

To summarize, the effect of scattering by the resin on the light intensity profile can be put into two main physical phenomena that are:
An exponential decrease of ballistic light with depth
An increased blur of the pattern along its propagation

In the case of a high coherence light source, such as a laser, the transmitted light generates a well contrasted figure of interference, the so-called speckle pattern. Interestingly, although very complex, it is possible to manipulate it thanks to wavefront shaping techniques. But this would require a characterization of the scattering resin at different depth and for all the angles, which is in practice really challenging. Another possibility is to measure the invariant patterns of light, also called invariant modes of the scattering medium, whose transmission is the same, irrespective of whether they scatter through the resin or propagate ballistically through a transparent material, as studied in Pai, P., Bosch, J., Kühmayer, M., Rotter, S., & Mosk, A. P. (2021), Scattering invariant modes of light in complex media. Nature Photonics, 1-4.

In the following, two separate preferred methods are described that aim at measuring and appropriately correcting for these phenomena. The method disclosed hereinafter that uses the scattering parameters by the method disclosed above can also use the scattering parameters obtained by the well-known angular scattering measurements for which a single detector rotates around the illuminated sample to collect the scattering strength as a function of angle. However, the angular scattering measurement is lengthy and needs to be performed in a separate set-up, complicating the system for a one inclusive printer.

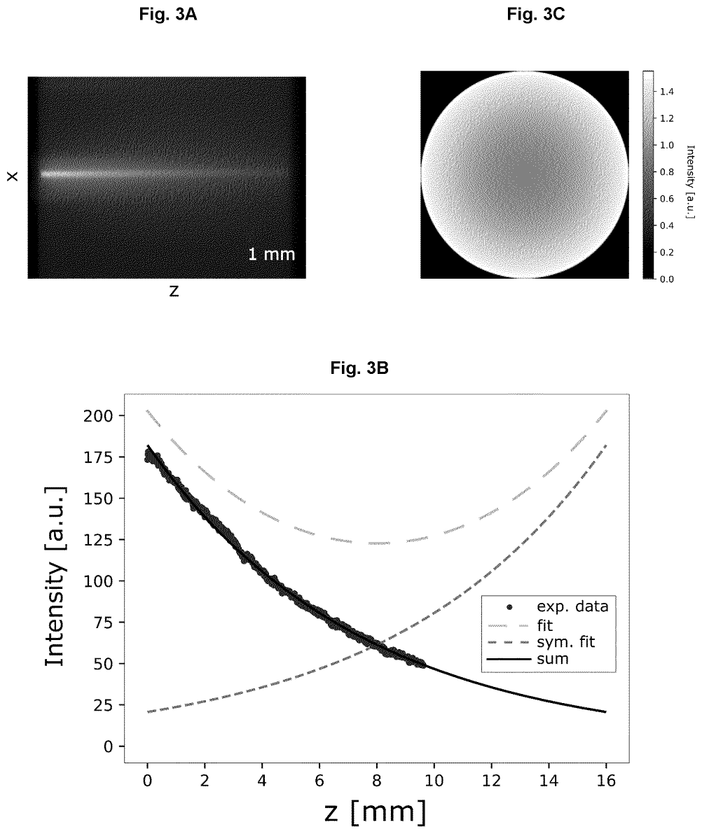

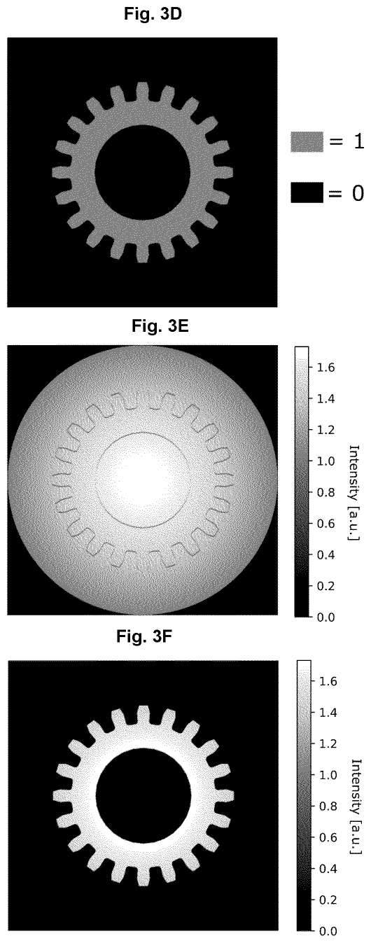

The main effect of light scattering is the exponential decrease of ballistic light intensity as a function of the penetration depth. Thanks to the side-view camera used in the first embodiment of the present invention shown in FIG. 1A, this first phenomenon can be recorded and analysed quantitatively. A preferred procedure according to the present invention for computing the appropriate correction is shown in FIG. 3. The procedure comprises sending through the resin a relatively narrow laser beam (in both x and y directions). In practice, this can be achieved by activating only a few pixels on the DMD. Propagation of light through the resin is affected by scattering and most of the photons are either randomly scattered or absorbed, see FIG. 3A. Only a small portion of light (also known as ballistic light) travels through the medium in a straight line. The amount of ballistic light as a function of depth is characterized by measuring the intensity decrease along the straight line. The corresponding experimental data are reported in FIG. 3B (dots) and fitted with a negative exponential (thin-line curve). Fitting coefficients provide an estimation of the scattering mean free path Iₛ, which is the average mean free path length between scattering events. The fit reported in FIG. 3B gives Iₛ=7.3 mm. The cuvette used for the measurement is only 10 mm thick, but the fit allows extrapolating the trend across the entire cuvette (cylindrical 16 mm diameter reservoir used for printing). In tomographic volumetric printing, the cuvette (i.e. the resin container) rotates with respect to its center, and it is thus necessary to consider the total amount of light deposited inside after a full rotation (360 degrees). In particular, after half a turn a similar exponential decrease of ballistic light is observed, because the TiO₂ particles are dispersed uniformly inside the resin. So in average the amount of ballistic light in the cuvette is the sum of the two negative exponential curves (FIG. 3B, bold-line curve and its symmetric with respect to the axis of rotation at z=8 mm in dashed). The sum of these two curves corresponds to the bold-line (top) curve in FIG. 3B. Because the decrease is exponential, the amount of light in the cuvette is not uniform after a full rotation. In particular, the proportion of ballistic photons is smallest at the center of rotation of the resin container. Here for the examined scattering resin, there is, in average, 40% less light in the middle of the cuvette (i.e. after 8 mm of propagation) than on the edges. In FIG. 3C, the two-dimensional profile of ballistic light across the cuvette (16 mm in diameter) is reconstructed. This is achieved by interpolating the bold-line curve reported in the plot of FIG. 3B in polar coordinates. This two-dimensional map is then inverted and gives access to what is designated herein as “correction mask” (FIG. 3E). To account for the exponential decrease of ballistic light inside the scattering resin, this correction mask is applied onto the binary object (FIG. 3D) prior to computing the light patterns with the Radon transform. The resulting light dose to project inside the resin to print, taking into consideration the attenuation of ballistic light, is represented in FIG. 3F. It corresponds to the product of the binary object with the correction mask.

Note that this attenuation correction is done here to compensate for the exponential decrease of ballistic light in a scattering resin. The effect of pure sample absorption can also be preferably added to account for the total light attenuation. A useful application is to correct light absorption from dyes or one or more photoinitiators. Absorption from photoinitiators is essential to polymerize the resin, but it limits the performance of the printing device, such as for resolution or print size. Usually, the concentration of one or more photoinitiators is chosen so that absorption is very small across the cuvette, but more light (i.e. more time) is needed to print. Also, correcting for the absorption of one or more photoinitiators offers the possibility to print faster, to print in weakly polymerizing or crosslinking materials, or to produce larger objects.

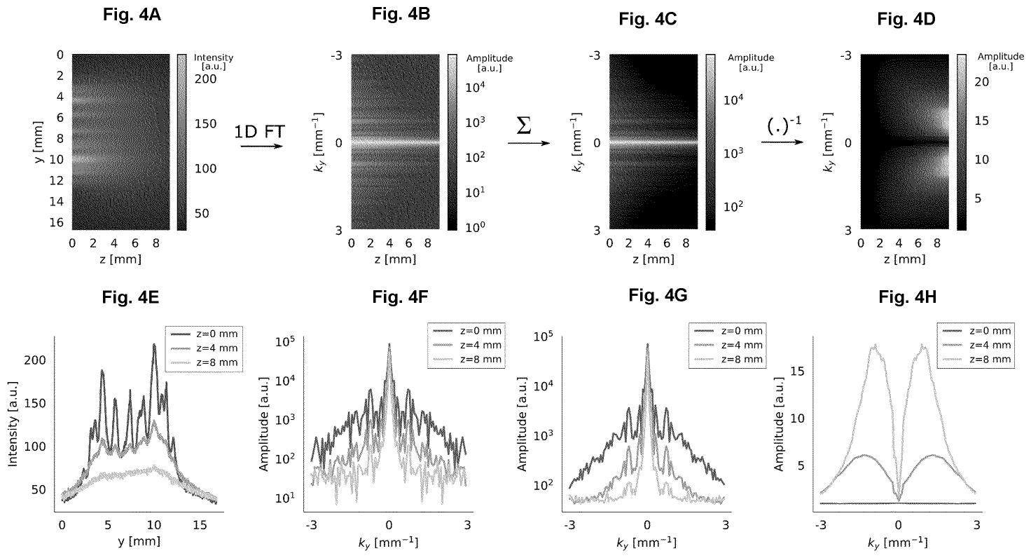

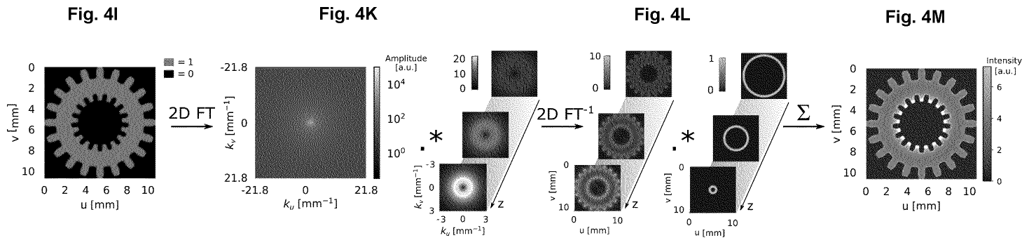

Hereinafter, another preferred correction is described to counter the effect of light scattering. As has been already mentioned, the scattering tends to change the direction of incident light. In addition to a strong decrease of ballistic light with depth, one can also notice that the beam broadens with penetration depth: the pattern gets increasingly blurred (see typical side-view picture in FIG. 4A and different z-profiles in FIG. 4E). In the frequency space (also referred to as “k-space” or “Fourier space” in the following), the scattering acts as a low-pass filter. In other words, the spatial features of high spatial frequencies in the pattern get more rapidly attenuated than the low ones. In FIG. 4B this is exemplified by computing the one-dimensional Fourier transform of FIG. 4A along the y-axis (corresponding profiles at different depths are shown in FIG. 4F). In order to properly characterize the transmission of all the spatial frequencies, a set of different patterns (here 100 patterns) is projected onto the DMD. Note that it is important to project patterns whose k-spaces are representative of the frequencies at stake when printing, as done in FIG. 4. Suitable sets of patterns include patterns from the Radon transform of the object, random patterns, patterns from the Fourier transform of images or signals, or designed dictionaries of patterns with different spatial frequencies, for example. For the projections of each one of these patterns, the corresponding images are acquired with an orthogonal (side view) camera, and their 1D Fourier transform is computed to get pictures as in FIG. 4B. Once summed, the result shown in FIG. 4C (and for different z-profiles in FIG. 4G) is retrieved. This image shows the strong attenuation of the high spatial frequencies as light penetrates in the material. To alleviate this unequal impact of scattering in k-space, preferably the amplitude of the frequency components (which are dampened by the scattering) is enhanced. According to these measurements, there is computed a correction mask that ensures to get the amplitudes of all the incident frequency components (at z=0 mm) constant across the full vial (at all depth z), see FIG. 4D. In practice, this is obtained by dividing the incident averaged spectrum (k-space domain) at z=0 mm by each spectrum taken at different z depths. This correction mask is depth-dependent, and profiles for different z are shown in FIG. 4H. They present two symmetric lobes whose amplitude varies with depth. As expected, the correction to apply is more important for high spatial frequencies up to a certain point above which the correction drops, simply because the initial energy (at z=0 mm) of the corresponding frequencies is very low. Note that these correction masks are 1D, but the target objects are 2D (or even 3D). Importantly, the effect of scattering in k-space should be the same whatever the direction kₓ, k_{y} or k_{z}, because the TiO₂ particles are homogeneously dispersed in the resin. So there can be easily computed a higher dimensional mask from the curves in FIG. 4H by using some symmetries. For instance, the 2D masks are obtained by applying an axial symmetry with respect to the central frequency k_{y}=0 mm⁻¹, see FIG. 4K. The correction can then be applied onto the target binary object (which is shown in FIG. 4I). The procedure comprises computing the two-dimensional Fourier transform of the object to access its frequency components. The two-dimensional Fourier transform is then filtered with the experimentally-estimated mask for each depth. The best coordinates to describe a tomographic system (as the one in FIG. 4I) are the polar coordinates. In this space, the penetration depth decreases radially with maximum attenuation at the center of the cuvette (i.e. 8 mm in the present embodiment). It is where the scattering of light causes the most difficulties and therefore where the correction is the most important. This filtering operation with respect to the Fourier transform needs to be repeated for the different depths, as the mask is depth-dependent. Then going back in the real space, the region is kept where the mask is valid, which looks like a ring whose radius is directly related to the depth of the applied correction and thickness determined by the chosen discretization step (FIG. 4L). The resulting corrected light dose to project onto the resin is then the sum of the annular dose distributions (FIG. 4M).

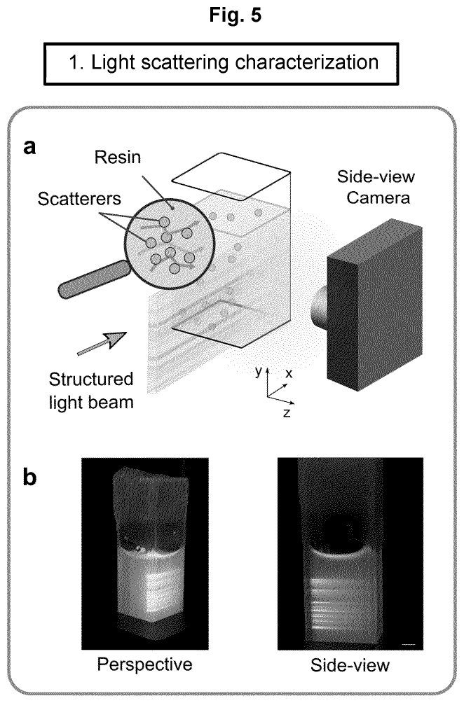

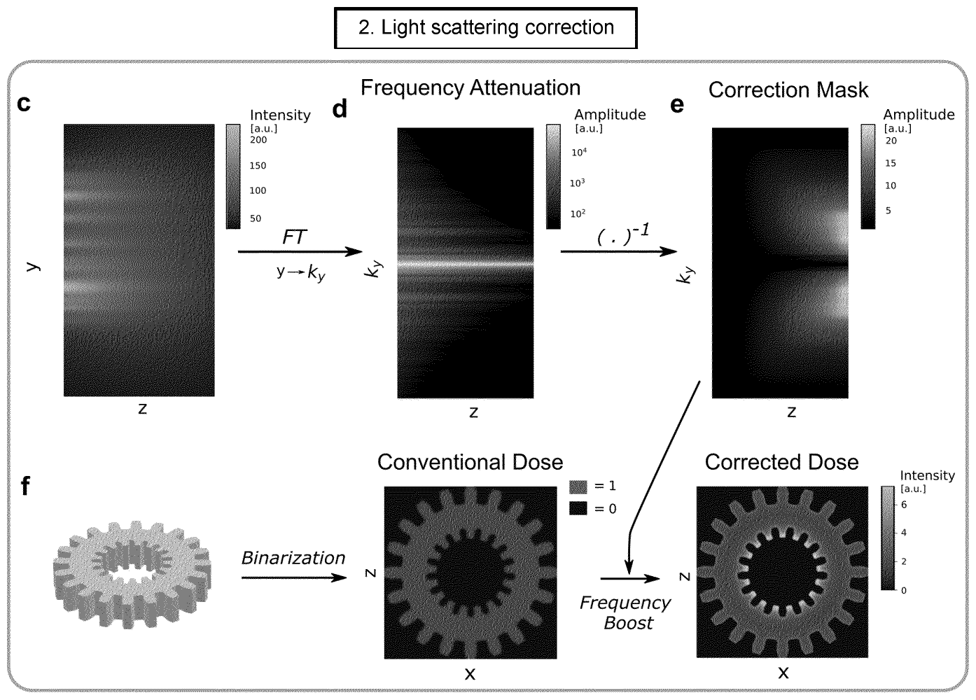

The method of the present invention is summarized in FIG. 5. Basically, the method comprises two steps. In a first step, a light scattering characterization is performed, using the device described above in FIG. 2B and reproduced here in FIG. 5A. Light scattering is exemplified in FIG. 5B, which is a reproduction of FIG. 2C. In a second step, a light scattering correction is performed, as already explained above. A side view picture of light scattering (see FIG. 5C) is subjected to 1D Fourier transformation (FIG. 5D), and a correction mask is retrieved therefrom (FIG. 5E). A target 3D model is subjected to binarization, and subsequently subjected to a frequency boost with the aid of a corrected dose determined using the correction mask of FIG. 5E (see FIG. 5F).

This disclosed method (summarized in FIG. 5) to compute the corrected light dose pattern from the scattering properties of the resin can also be applied to other printing technologies, such as stereolithography (point wise), DLP printing (layer-by-layer), and also to more recent techniques like xolography (Regehly, M., Garmshausen, Y., Reuter, M., König, N. F., Israel, E., Kelly, D. P., & Hecht, S. (2020). Xolography for linear volumetric 3D printing. Nature, 588(7839), 620-624.), two photon printing, longitudinal or multi-axial setups. In all these cases, the first step is to characterize the scattering parameters according to the present invention, and then the patterns are computed to correct for scattering as a function of penetration depth.

Above, two preferred different approaches were discussed in detail to take into account the two main effects of light scattering on the propagation of the patterns. In both cases it was explained in detail how to derive the correct light dose in order to increase the print fidelity. Hereinafter, the computation of the 2D light patterns is explained in further detail. As a difference from standard approaches, the input of the algorithm is not the binary model of the 3D object, but rather the light dose (intensity values) one would like to deposit inside the cuvette. Although the two approaches are equal when working in a transparent resin (assuming light propagates in a straight line and is not attenuated along its propagation), this is no longer true if one wants to keep high fidelity for the prints using non-transparent resins, as detailed previously.

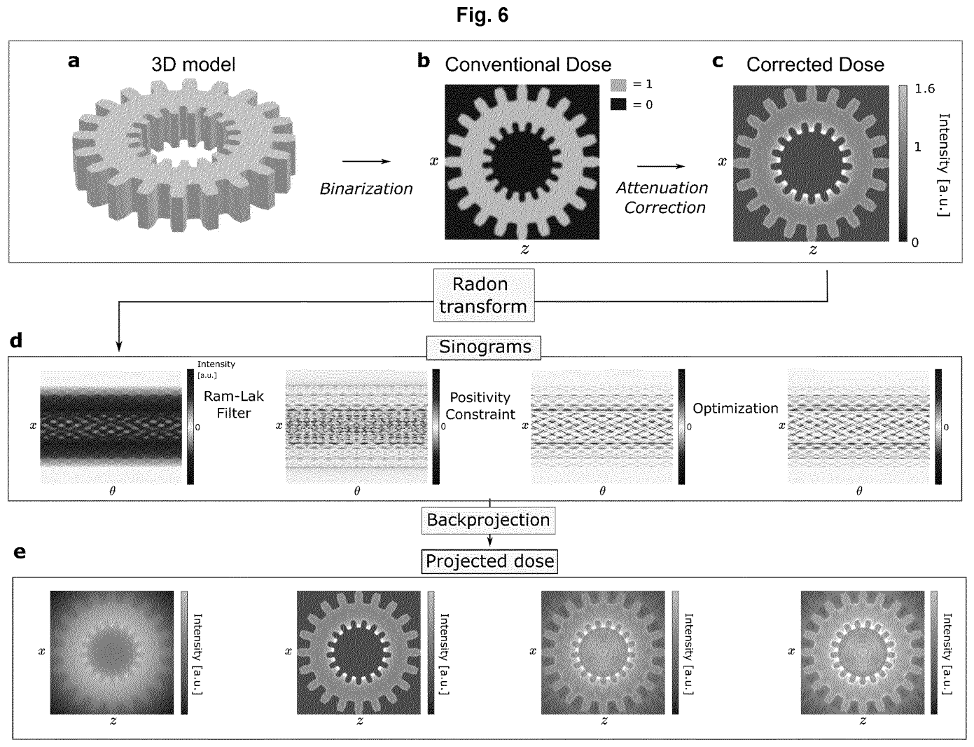

A simplified workflow of an example of a suitable algorithm is sketched in FIG. 6. From the target light dose (here 2D, for sake of simplicity) obtained as shown in FIGS. 6A-C and as described above with respect to FIG. 5, a Radon transform is performed. The obtained sinogram shown in the first picture from the left of FIG. 6D is filtered with respect to its Fourier transform to compensate for the oversampling of the low spatial frequencies. In this embodiment, a known Ram-Lak filter is used, and the filtered sinogram shown in the second picture from the left of FIG. 6D is obtained. If this filtering operation is not done, the cumulative dose projected into the resin (using back-projection described above) would be blurred and compromise printing resolution. This is exemplified by the first two pictures from the left in FIG. 6E, where the first picture from the left shows the blurred print obtained using the unfiltered sinogram of the first picture of FIG. 6d, and the second picture from the left shows the improved print obtained using the filtered sinogram of the second picture of FIG. 6D.

Nevertheless, this filtering step generates negative values that cannot be optically implemented. They are set to zero (as shown in the third picture from the left of FIG. 6D where said positivity constraint has been applied), which creates some artefacts (as shown in the print illustrated in third picture from the left of FIG. 6E). An optimization is generally run (see fourth picture from the left of FIG. 6D) to improve the fidelity between the target dose and the sinogram back-projection (see fourth picture from the left of FIG. 6E). These steps are performed here very similarly, but more efforts are put in the final optimization. Indeed, the target to be achieved according to the present invention is not binary but real positive, which makes the optimization more complex. Therefore, the forward model is modified and the number of iterations increased, but the gradient descent still provides a significant improvement of the patterns. The code is written in python and uses the pytorch library, so that it can be run under GPU.

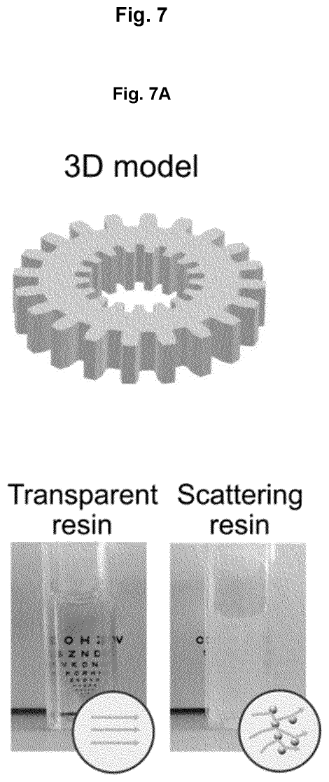

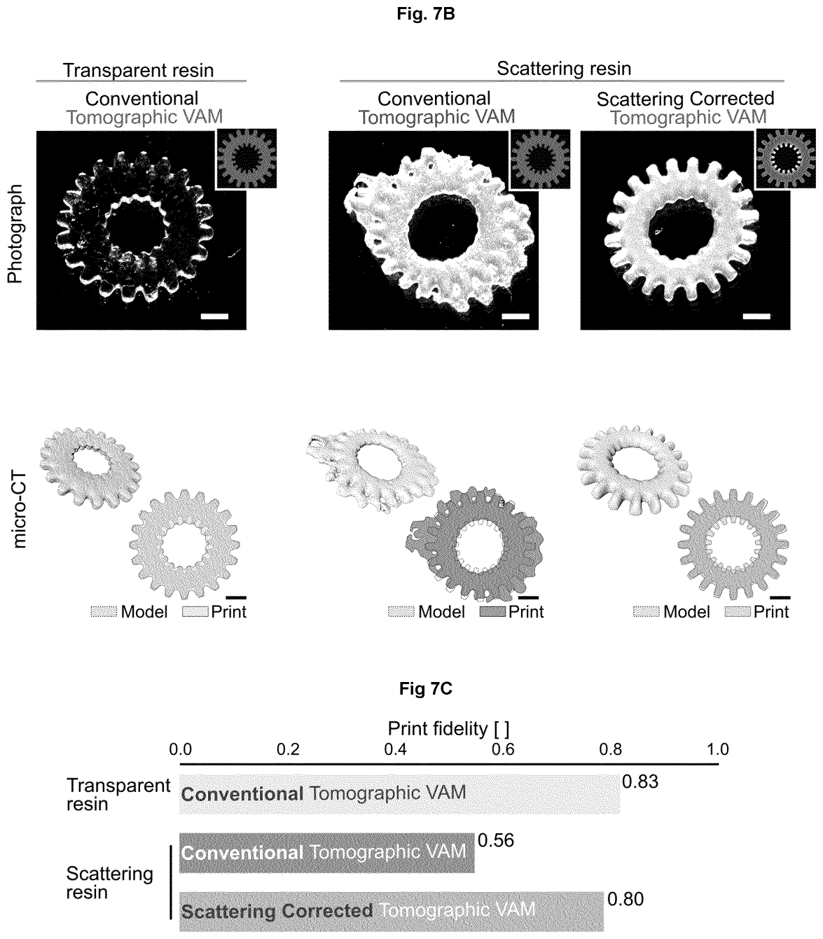

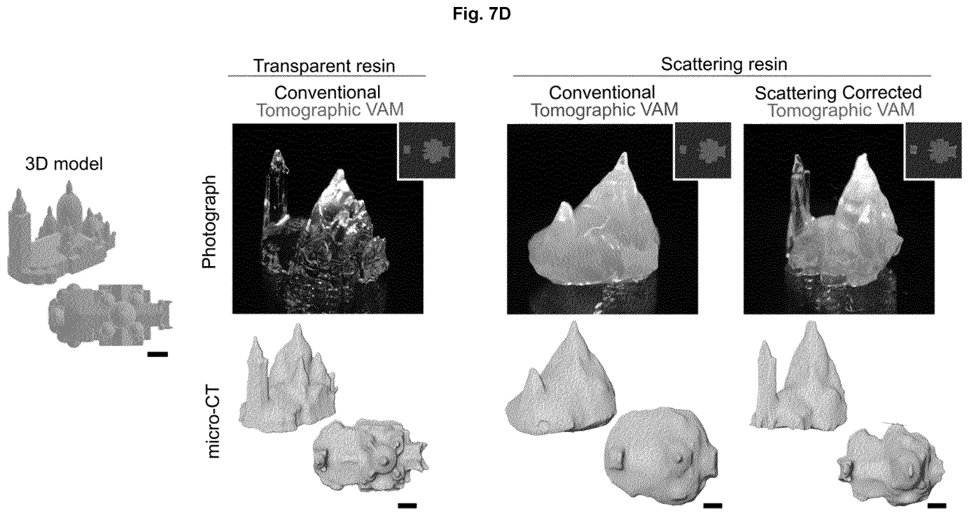

The forward model and gradient descent algorithm performance results are reported in FIGS. 7, 8 and 9.

FIG. 7 is a visualization of results obtained with the method according to the first embodiment. FIG. 7a shows a target 3D model and exemplary transparent (left) and scattering (right) resins

FIG. 7b shows in the upper row exemplary photographs of the target 3D model of FIG. 7A in a transparent resin and a scattering resin, wherein the center photograph has been made using conventional tomographic VAM, and the right photograph has been made using tomographic VAM that has been corrected for scattering with the method of the present invention.

FIG. 7B furthermore shows in the lower row a model (micro-CT) of a part printed in transparent resin, with (scattering corrected tomographic VAM) and without (conventional tomographic VAM) corrections for scattering. Quantitative measurement of print fidelity from Jaccard index (a higher value is better) of microtomography sections against the printing model was performed. It can be seen the clear improvement obtained by using tomographic VAM that has been corrected for scattering with the method of the present invention.

FIG. 7C shows the performance of the scattering correction according to the present invention. Using tomographic VAM that has been corrected for scattering with the method of the present invention results to a print quality in scattering resins that is comparable to the print quality in transparent resins.

FIG. 7D shows the performance of the scattering correction for a true 3D object. Using tomographic VAM that has been corrected for scattering with the method of the present invention results in a printed object from a scattering resin that comes much closer in quality to a printed object in transparent resins.

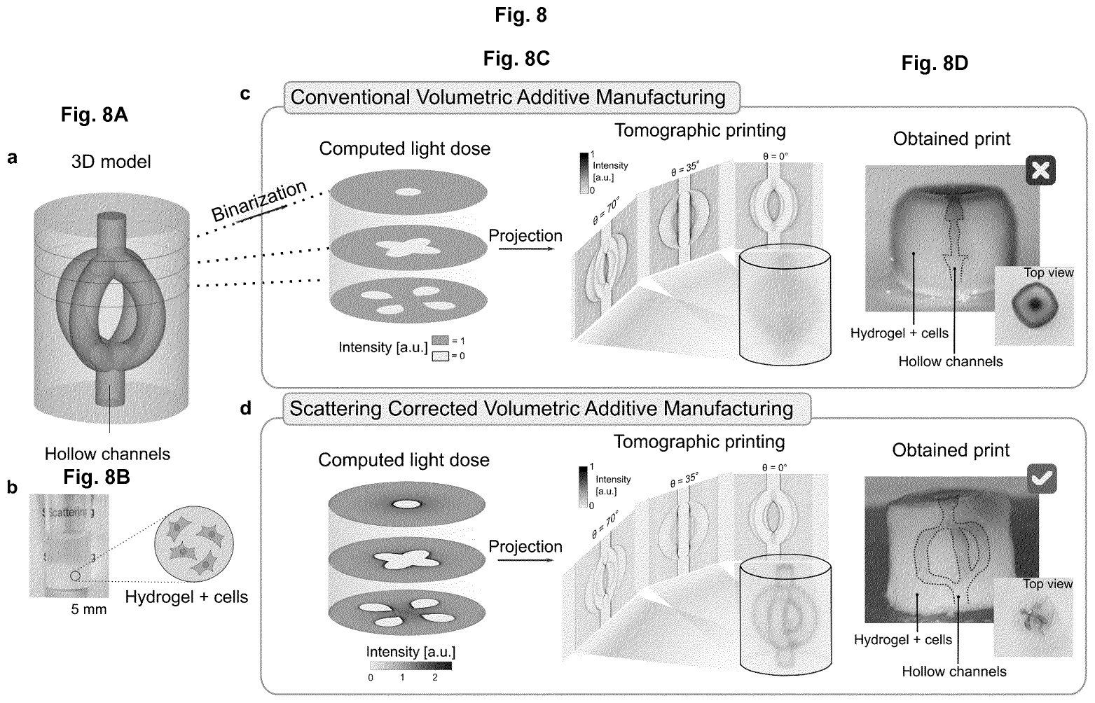

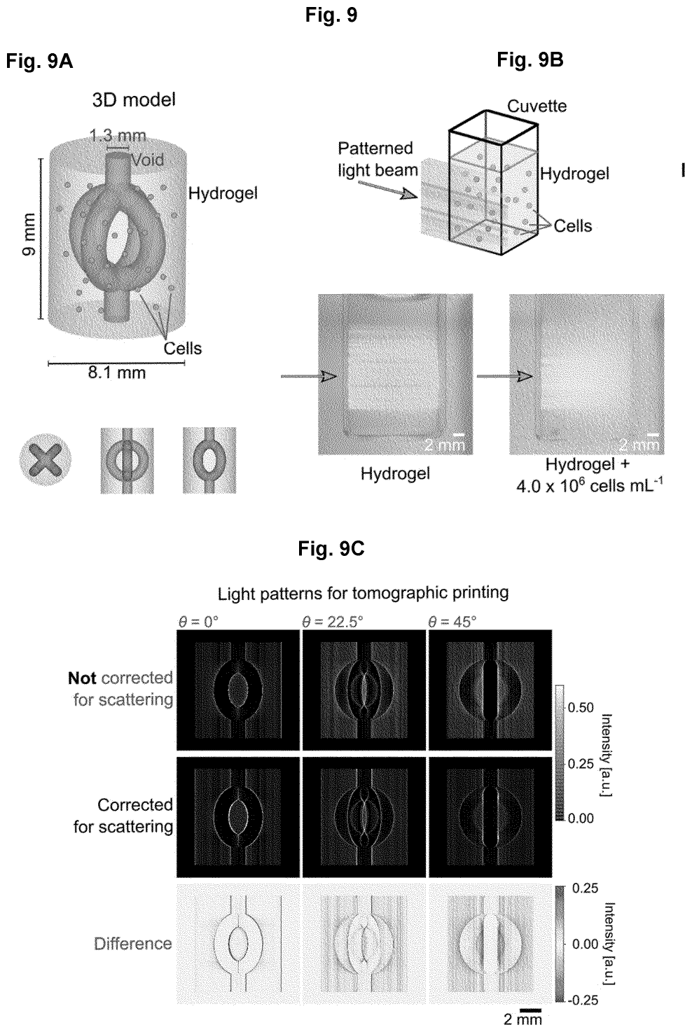

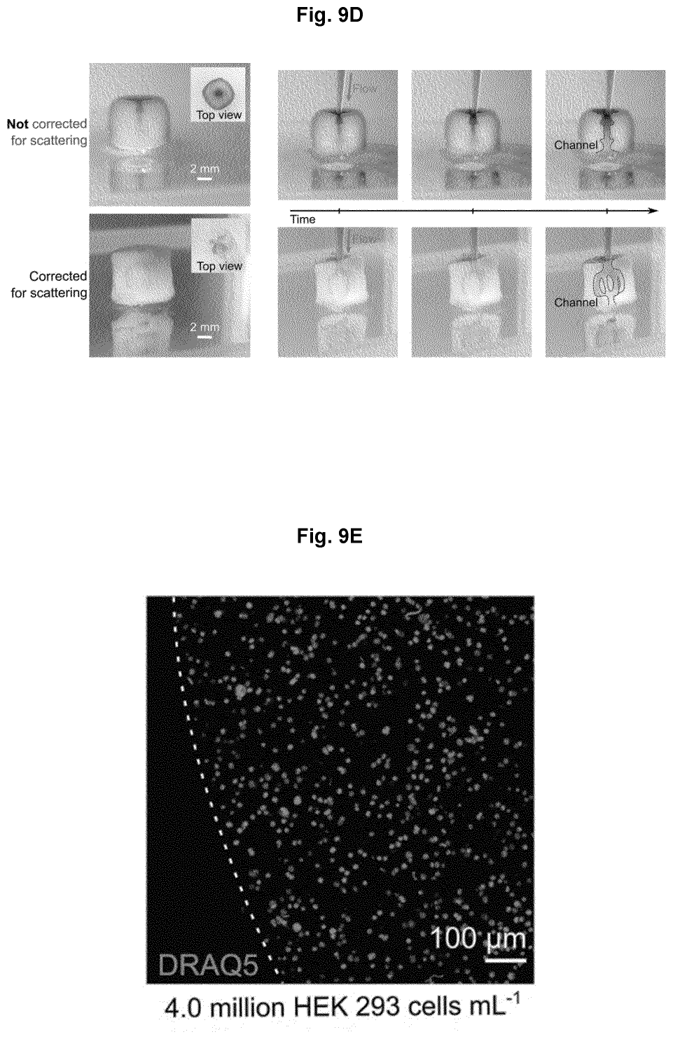

In FIGS. 8 and 9, the scattering correction is applied to a different scattering resin, that is hydrogel loaded with living cells. The latter act as scatterers and prevents 3D constructs from being bioprinted with high fidelity and resolution, limiting the conventional tomographic printing process to relatively simple 3D geometries. Bioprinting of cm-scale constructs is challenging because hollow channels must be left open to allow for the inflow of nutrients and oxygen to the cells deep inside the hydrogel.

To show the performance of the proposed scattering correction, a complex geometry of a 4-mm solid core surrounded by four millimetric channels is chosen to be printed (see FIG. 8A and FIG. 9A). Cell-laden hydrogels may be highly scattering (visualization in FIG. 8B with a white lamp and in FIG. 9B with a structured blue light pattern). For volumetric light-based biofabrication methods, this constrains bioprinting at very low cell concentration, limiting the viability of the construct over time. The proposed scattering correction according to the present invention spatially redistributes light as it is sent in the tomographic patterns. As shown in FIG. 8C (resulting 3D dose) and FIG. 9C (corresponding 2D light patterns), to avoid over-polymerization and clogging the channels, in conventional VAM more light is sent to the fine features of the edges while less light is sent to the bulk of the construct. The overall light dose (19.1+/−5.2 mJ cm⁻², equivalent to 6.4 mJ cm⁻³) and printing time (36 seconds) were the same to produce the uncorrected and corrected objects in FIG. 8D also in FIG. 9D. Tomographic volumetric bioprinting has been shown to have high cell viability immediately after printing and several days after printing. Importantly, the proposed scattering correction according to the present invention does not change the required light dose to produce a print, and results in small changes in the local light intensities of the projected patterns, so that cell viability should not be compromised.

Instead of evaluating the fidelity of the prints (these hydrogels are soft and deform on their weight), it was evaluated if all design features are present. The timelapse in FIG. 9D showed a dark blue liquid dye as it was pumped through the constructs. Conventional tomographic VAM yielded clogged channels and a void core. This comes from the fact that the correct light distribution does not reach the center of the vial during fabrication. Note that a functional object could not be achieved by using either a lower light dose (this would produce unclogged channels, but the core would still be void) or a higher light dose (this would produce a solid core, but channels would still be clogged). Scattering-corrected Tomographic VAM produced a cm-scale construct with all four channels unclogged and a solid core in a soft hydrogel loaded with 4 million HEK 293 cells mL⁻¹ (FIG. 9E). Previous reports have demonstrated the fabrication of similar structures under concentrations of only 10 000 or 1 million cells mL⁻¹. At a concentration of 4 million cells mL⁻¹, the scattering mean free path of the resin is I_s=3.6 mm. The cell-laden constructs were printed in vials whose inner diameter is L=13 mm. it must be emphasized here that the cell concentration in the gel could potentially be further increased by printing in smaller vials, as what limits tomographic VAM is the ratio I_s/L.

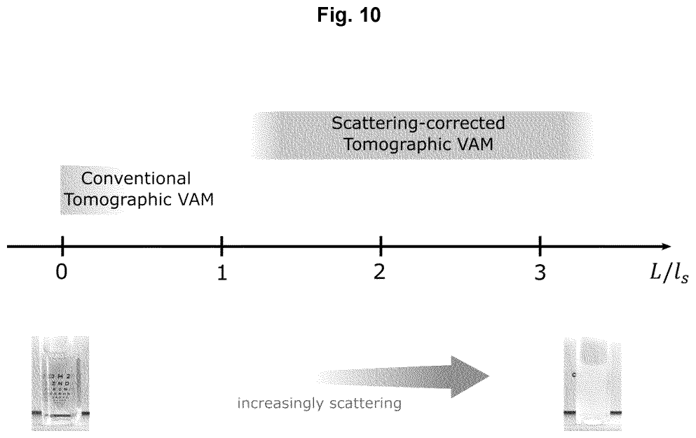

As detailed in FIG. 10, the technique according to the present invention enables printing with similar fidelity than conventional tomographic printers but in materials where the amount of scattering is 3 times larger.

Additionally, said scattering invariant modes can be used to project undistorted patterns into a scattering resin. These modes can either be measured or calculated from the scattering properties of the medium. They can be used as a basis for decomposing the set of patterns that produces the desired 3d object by volumetric printing. The set of patterns can be obtained via the Radon transform for tomographic printing or in the case of Xolography by computing one or a set of multiple invariant modes that approximate the 2D spatial pattern projected in a given depth layer. The set of patterns are then projected with a spatial light modulator. These modes can be used to cause polymerization of the full object in the resin or to overprint fine high-frequency features.

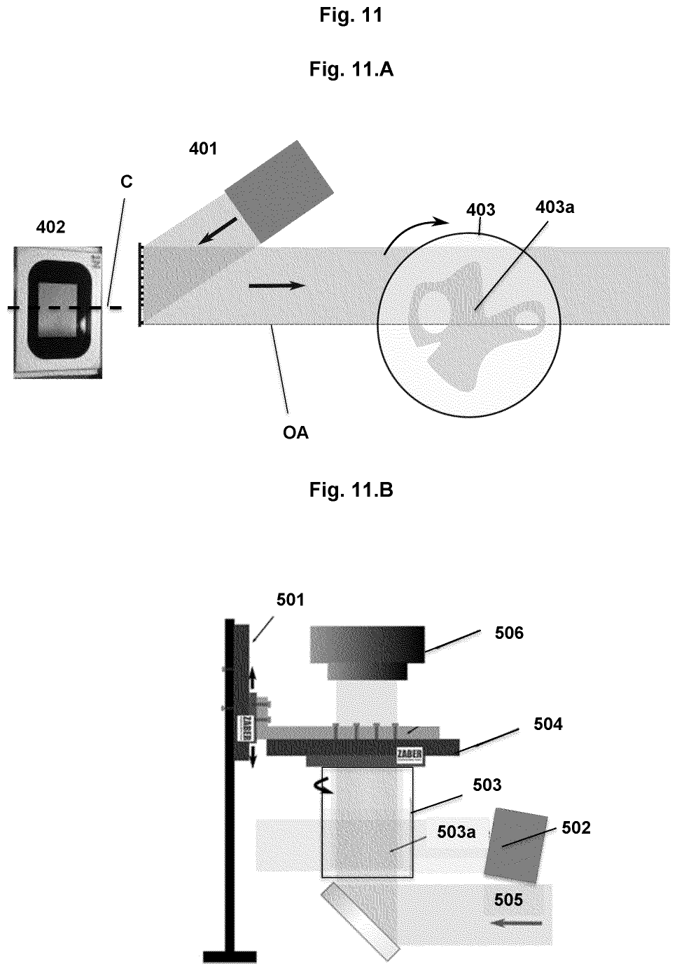

In tomographic volumetric printing, the spatial resolution is directly related to the number of pixels offered by the light modulator (e.g. DMD). Using a telescope, the mask displayed onto the light modulator (e.g. DMD) can easily be magnified (respectively demagnified), which increases (respectively decreases) both the pixel and object size. Naturally their ratio is constant, which means that doubling the object size also increases the voxel size by a factor two. Here, a new setup geometry is proposed that enables to print a larger object with the same optical elements (same DMD, telescope etc.) and keeping the same resolution (i.e. voxel size). This embodiment of a device according to the present invention comprises off-centering the spatial light modulator, such as a DMD, with respect to the optical axis, as shown in FIG. 11a. In this embodiment, an optical setup is used in which a light source 401 illuminates a digital projector or light modulator 402 which is positioned off-center from the vessel (container) 403 containing the photopolymer 403a. According to the present invention, “off-centering” means that the center C of the spatial light modulator 402 (i.e. a notional line parallel to the optical axis from the spatial light modulator to the resin container 403 and intersecting the light modulator 402 into two portions of the same length and width) is not on the optical axis OA from the spatial light modulator to the resin container 403 (i.e. the axis going straight from the light modulator 402 through the center of the resin container 403), but is shifted to the left or right from said optical axis OA to such an extent that the entire light pattern sent from the light modulator 402 still enters the resin container 403. By off-centering the spatial light modulator, it is possible to illuminate approximately the left or right half of the vessel. This method can increase the lateral build dimension or the 3D print size by a factor 2 while maintaining the lateral resolution.

In FIG. 11b, a side view of another embodiment of a device according to the present invention is shown. FIG. 11b shows the implementation of a transport device 501, such as a linear stage, to move a vessel (container) 503 with transparent or non-transparent resin 503a up and down with respect to a projector or light modulator 502 to print taller objects. Said up and down movement of the transport device can be carried out using a motor, preferably an electric motor, that operates a conventional mechanism for generating a linear movement. This method is inspired by spiral/helical computed tomography, widely used in medical spiral/helical imaging, for example for scanning the whole human body. It has however not been implemented for volumetric printing.

Preferably, a rotator 504 is provided which is attached to the transport device 501 and to the vessel (container) 503 with transparent or non-transparent resin 503a. By means of vertical movement of the rotator 504 caused by a vertical movement of the transport device 501, the vessel (container) 503 with transparent or non-transparent resin 503a is moved up and down. Moreover, the rotator 504 allows to project light from multiple angles, by rotating the vessel (container) 503 with transparent or non-transparent resin 503a relative to the light source 505. Said rotational movement can also be carried out using a motor, preferably an electric motoer, that operates a conventional mechanism for generating a rotational movement. The motors for causing the linear and rotational movement of the rotoator 104 may be the same or different. According to a preferred embodiment, light from a second light source 505 is sent approximately orthogonally to the direction of the printing light in order to monitor the state of the print in the vessel 503 with a camera 506.

According to this embodiment of the present invention, any photosensitive material (transparent or non-transparent and optionally scattering and/or absorptive) may be used.

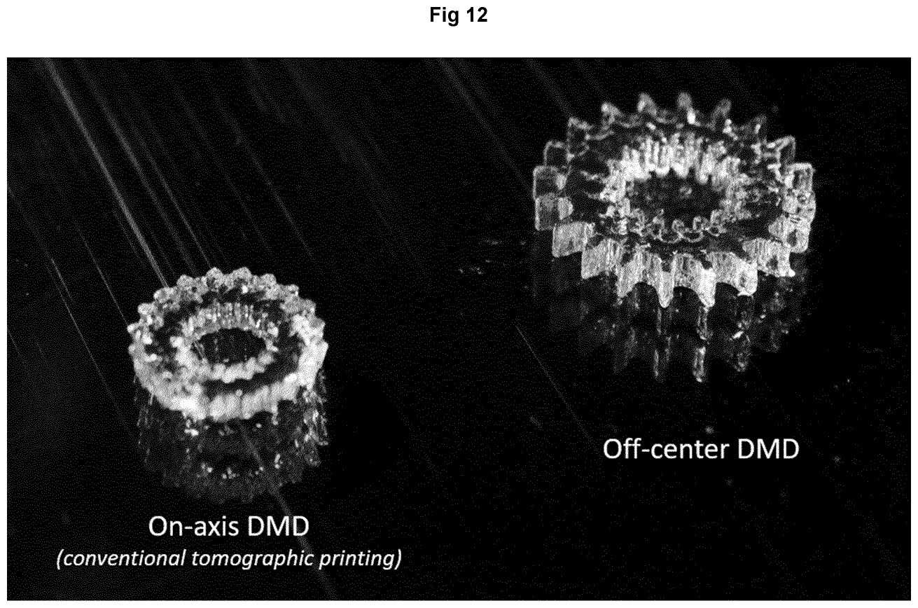

Although the DMD is usually centered with respect to the optical axis, there is no particular reason for that. Off-centering the DMD offers the possibility to use all the DMD pixels to only half of the object and not the full part, enhancing the printer's lateral resolution by a factor two. Because the vial is in rotation, the full object nonetheless is printed and not simply its half. With the same laser power, this implementation comes at the cost of time, as it would indeed require to send twice more light into the cuvette to reach the polymerization threshold and thus solidify the resin in the desire geometry. Printing improvements using an off center DMD are shown in FIG. 12.

This concept of off-centering the DMD optimizes the use of the DMD, but only changes the printer's resolution laterally. To also improve the printer's capability along the vertical axis, it is proposed to mount the vial on a linear stage that provides the opportunity to move it up and down with respect to the DMD (see FIG. 11b). This is inspired from spiral/helical computed tomography already currently used in medical imaging.

To monitor the printing in real time, according to a preferred embodiment of the present invention an imaging system is implemented that uses a red LED (or any other light source wavelength which does not solidify the resin) and a camera centered onto the optical axis of said red LED (or other suitable light source), so as to altogether image the projected light patterns and carry out the solidification process at the same time. As represented in FIG. 11B, the camera can also be aligned with the rotation axis, making top-view images of the rotated vial.

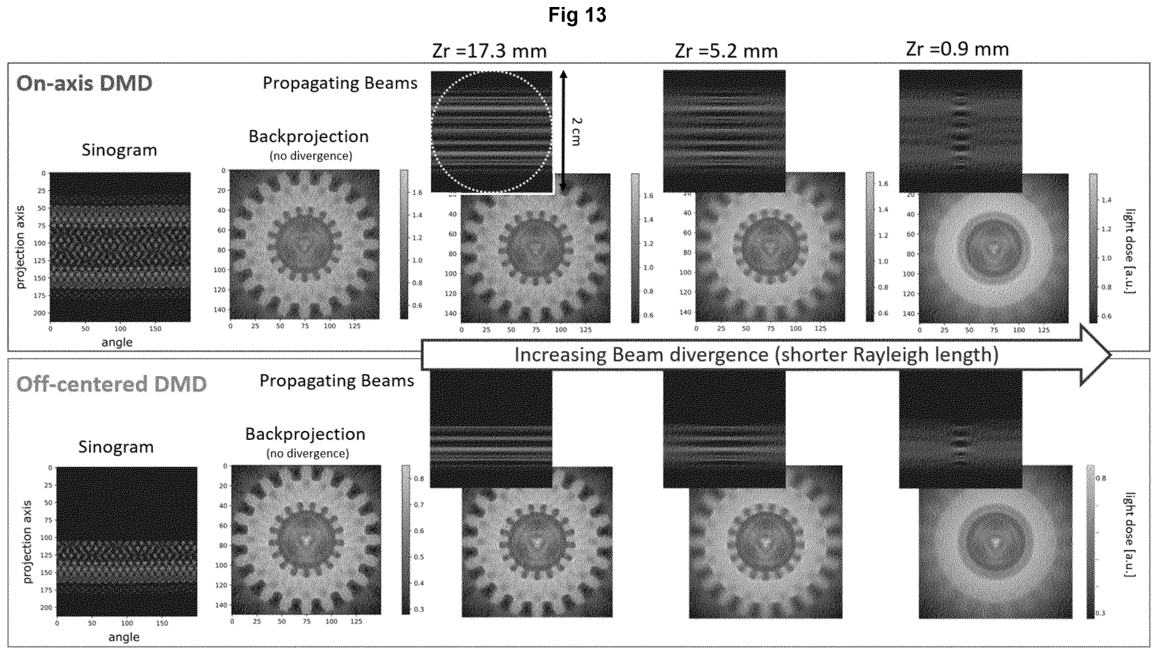

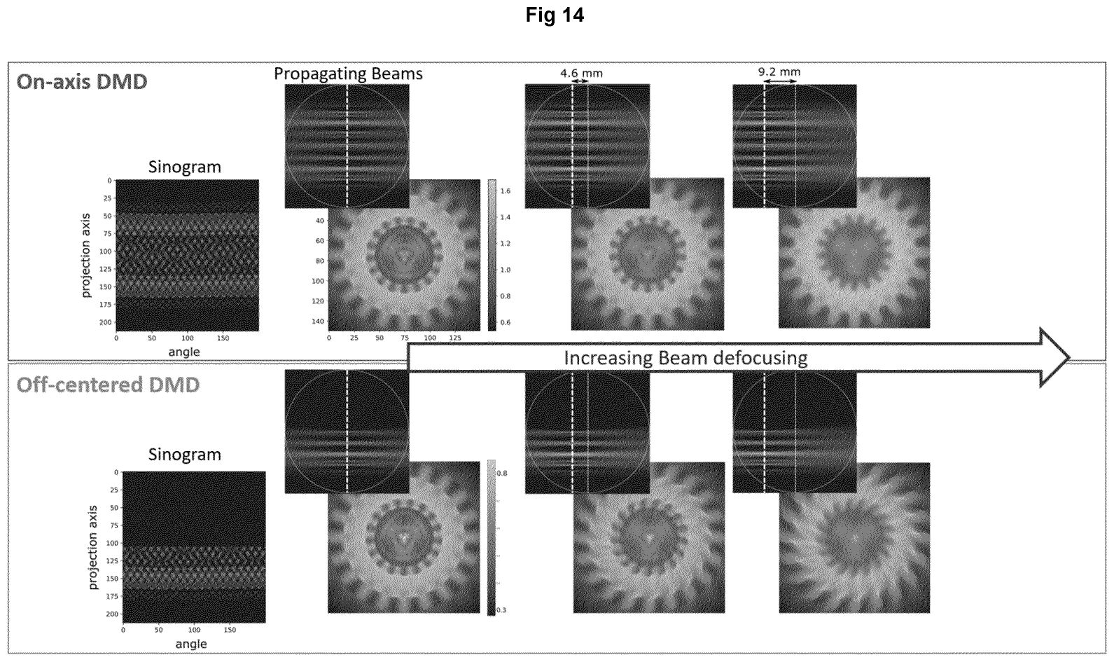

FIGS. 13 and 14 demonstrate through simulations the importance of decreasing the divergence of the projected patterns along the optical axis as much as possible (i.e., minimizing low-etendue of the light source). Also, aligning the vial with the focal plane with accuracy is fundamental to limit the defocusing (see FIG. 14) of the projected patterns and the resulting effect of the projection asymmetry (off center DMD).

In 3-D printing involving light, the latter induces a chemical reaction in a photoresist (photosensitive material, preferably resin), mediated by a photoinitiator that is mixed into the resin. The reaction brings the liquid resist, which often is provided as a monomer, into a cross-linked solid state—a polymer. As it has already been explained previously, the solidification process can be achieved using a tomographic approach; it results in the achievement that the entire object is printed at once.

Other techniques were also proposed, such as stereolithography (SLA) in which a focused laser beam is used as a “pen of light” to write in three dimensions and print the desired shape. This strategy is interesting as it offers high resolution, even higher when considering a multi-photon absorption process. Indeed, the amount of local cross-linking depends on the accumulated absorbed dose. In two-photon absorption, the absorbed dose is proportional to the square of the local intensity which makes the two-photon focal spot size much smaller than in one-photon and more importantly, limits the elongation of the voxel in the direction of the focus, which allows to print a part in 3D by scanning the focus point within the volume of the resin. Two photon printing has shown resolution of only a few tens to a hundreds nanometers. Also when using higher excitation wavelength (like NIR light), light can penetrate into deep biological tissue, in contrast to UV or blue light which has a poor tissue-penetration capacity.

According to a further embodiment of the present invention, it is proposed to combine tomographic volumetric printing that is fast and does not require any support structure, with two-photon or multi-photon absorption that provides high localized resolution. In practice, the print can be obtained after a procedure comprising two separate steps. A first step involves delivering a 3D light dose of desired print shape in the main body of the photosensitive material with a tomographic volumetric printing approach. Importantly, the 3D light dose delivered in this first step is below the gelation threshold of the resin, i.e. below the threshold energy required for initiating cross-linking of the resin. This first step exhibits high efficiency and high speed. Subsequently, the resin is illuminated with a focused laser beam at longer wavelength, such as in the near infrared, that is absorbed, via a multi-photon process, such as a two-photon process. In the multi-photon process, the photons can be absorbed by so-called two photon photoinitiators which create radicals that promote photopolymerization. The two or multi photon absorption process can also be implemented via nanoparticles or colorants (e.g. dyes), that generate UV light, blue and red light via multi-photon absorption. In the case of non-linear absorption by the said nanoparticles or dyes, the purpose is to convert near infrared photons into visible photons in a non-linear fashion so as to limit the axial extent of the absorbed dose, preferably in the range of 320 to 650 nm. This light emitted by the nanoparticles or dye is then absorbed by single photon photoinitiators to promote photopolymerization.

According to this embodiment, any photosensitive material (transparent or non-transparent and optionally scattering and/or absorptive) may be used.

FIG. 16A shows an example of a device that can be used for implementing the above two-step procedure wherein step 1 is a single photon process by said volumetric printing using reverse tomography and step 2 uses a multi-photon process such as but not limited to a two photon absorption process. A laser 601, emitting for example light at a wavelength of 405 nm with a power of around 3 W, transmits light to a DMD 602, which projects the light patterns of desired print shape into a sample part 603, preferably through a mechanical iris 602a. The sample part 603 preferably comprises a container in which photosensitive material (resin) is provided. The 3D light dose delivered in this first step is below the gelation threshold of the resin. A second laser 604 emitting light of a longer wavelength, for example, a laser emitting light at a wavelength of 976 nm with an average power of around 3 W or in another example a femtosecond laser emitting light at approximately 780 nm, transmits light to a DMD 605, which projects the light patterns into the sample part 603. A fiber is shown as an example to guide light to the DMD 605. Alternatively, free space components such as mirrors and lenses can relay light from the laser 604 to the DMD 605, as is well known in the literature. A photomultiplier tube 606 may be provided to observe backscattered optical signal from the resin in vial 603. A camera 607 may be provided for monitoring the progress of the photopolymerization in the sample part 603. Furthermore, a processing unit 608 such as a conventional computer may be provided for controlling various components, such as the DMD 602 or the camera 607. When nanoparticles are used for to their excellent conversion efficiency from infrared to the visible and ultraviolet, it is preferred to use lanthanide-doped up-conversion nanoparticles (UCNPs) in a projection tomographic system. The 800 nm wavelength may be preferable as the up-conversion window limits the thermal effect on water present in biogels compared with excitation at 976 nm. It is thus preferred to make use of available up-converting nanoparticles, UCNPS, with core/shell doped with Nd³⁺. The advantage of using UCNPs over a direct two-photon process is that cheaper continuous-wavelength lasers (e.g 976 nm cw source) can be used instead of a femtosecond laser.

In one embodiment, the DMD 605 can be replaced by a planar mirror.

According to this embodiment, this approach comprises 2-steps:
In a first step, a light dose is delivered via laser 601, DMD 602, and mechanical iris 602a to the sample part 603. The 3D light dose is computed, according to the tomographic printing method disclosed herein for scattering media or the tomographic method for transparent media disclosed before, such that it is not sufficient to cross the gelation threshold in any of the 3D voxels. Hence the 3D structure is latent. To obtain the maximal latent resolution, it is ensured that the spot is diffraction-limited using wavefront-shaping techniques exploiting the fluorescence from the particles as signal for feedback. This can be done by shaping the NIR light with a spatial light modulator prior to sending it inside the resin.
In a second step, a longer wavelength and non linear absorption is used to overpass the gelation threshold of the said latent 3D image by locally by scanning a focus or multi focus in the resin with the use of the DMD 605. The DMD 605 can, for example, add a quadratic phase front to axially move the focus obtained with the lens placed between the DMD 605 and the sample part 603. Alternatively, the focus can be moved by moving the said lens axially so that the focused beam is displaced in the print resin. In this latter case, a fixed mirror can replace the DMD 605. In this second step, the dose necessary to overcome the gelation threshold is low, which will significantly increase the printing time and increase the print resolution. By rotating the vial and having a focused spot which can be moved axially from the side of the vial to the center of the vial, a 2D slice of the object can be printed. By adding a vertical scanning of the said focus spot, for example, but not limited by moving the vial vertically, the full 3D object volume can be accessible to produce the 3D object.
Thus, by combining step 1 and step 2, a large scale and high resolved print can be obtained in a fast manner.

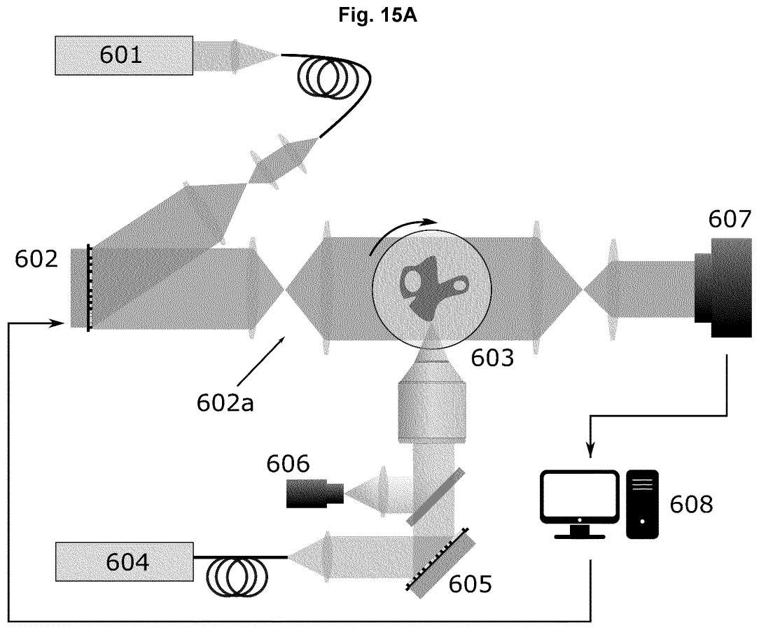

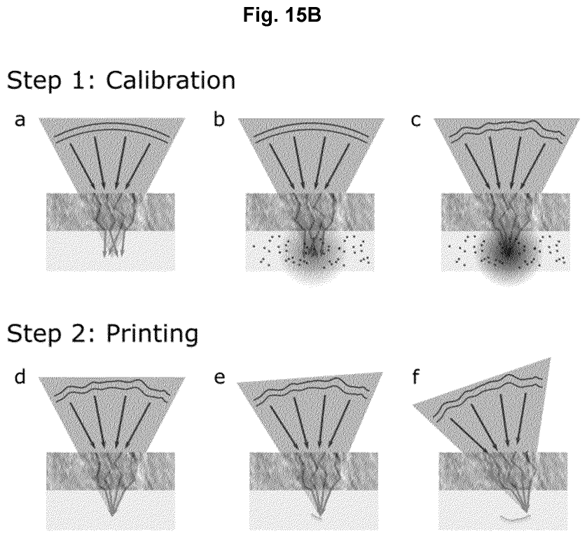

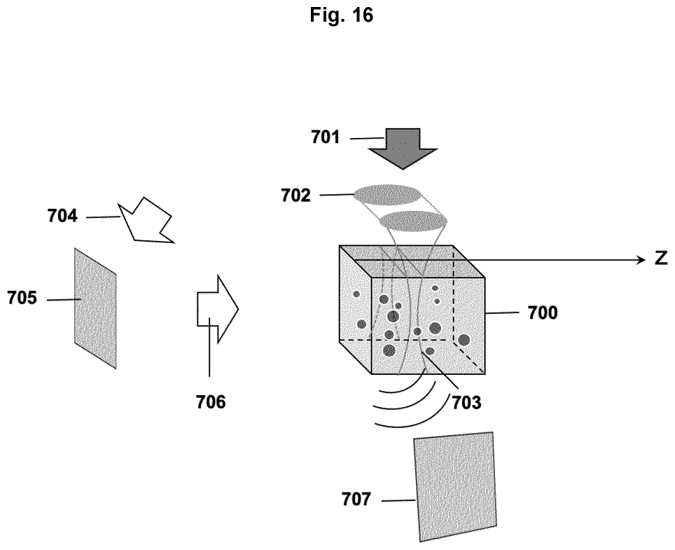

When the resin is scattering, the DMD 605 is used to add a spatial pre-compensation pattern onto the optical laser beam 604 to produce a so called correction phase front in order to focus the optical beam in the scattering resin contained in the vial. FIG. 15B is a schematic diagram of the steps to calibrate the phase front from fluorescent particles behind or in the sample, and to print with corrected wavefronts. In step 1, the wavefront shaping technique is used exploiting the fluorescence from the particles as signal for feedback, in order to obtain a wavefront of desired shape. The calibration is performed repeatedely in sub-steps a to c. In Step 2, the wavefront of desired shape is used for printing. In sub-steps d-f, the focused beam is moved in the print resin, resulting in a large scale and high resolved print.

FIG. 16 shows another embodiment of the present invention for the scattering pattern correction introduced in FIGS. 1 to 5. A scattering resin inside the resin container 700 is first characterized according to the embodiment involving scattering correction presented above with the use of the DMD 705 that produces a light pattern 706 after illumination by a first light source 704. For each specific depth Z inside the resin container 700, the 2D pattern on the DMD 705 is computed such that the intensity pattern at propagating a depth Z inside the scattering resin in the resin container 700 is as similar as possible to the desired pattern (using any error function such as pixel wise error, correlation that is common in the field when comparing too similar 2D patterns). At depth Z, a thin slice also called sheet 703, 707 in the literature, is sensitized with a second light source wavelength 701 according to the principle of Xolography mentioned above. The slice 703 is produced by focusing the said second light source 701 by a cylindrical lens 702. The light pattern propagating in the scattering resin is corrected according to the present invention, in order to obtain a higher fidelity pattern at a desired depth inside the resin. The steps to produce the 3D object are to repeat the procedure for each specific depth in order to correct the pattern at each depth.

In all embodiments disclosed, one can use multiple wavelengths simultaneously that are tuned to the absorption features of the resin. The absorption features can be for example, but not limited to, photoinitiators, photoswitchable molecules, or inhibitors.

1-18. (canceled)

19. A method of volumetric manufacturing a three-dimensional object or article by illuminating a non-transparent and/or absorptive photo-sensitive material with light patterns from multiple angles, said method comprising the steps of:
a) capturing at least one fluorescence or scattering snapshot for one or a set of different illuminating projected patterns in said photo-sensitive material,
b) obtaining from said at least one snapshot at least one physical parameter describing the light propagation through said photo-sensitive material,
c) computing a set of optimized projected patterns with the aid of the at least one physical parameter obtained in step b), wherein said optimized projected patterns are used for volumetric manufacturing said three-dimensional object or article.

20. The method according to claim 19, wherein the at least one fluorescence or scattering snapshot is captured with a side view camera.

21. The method according to claim 19, wherein the light patterns are projected onto the photo-sensitive material with a spatial light modulator.

22. The method according to claim 19, wherein the photo-sensitive material comprises a fluorescent dye for generating a fluorescence signal to be captured as a fluorescence or scattering snapshot.

23. The method according to claim 19, wherein step b) is performed by determining an exponential decrease of ballistic light intensity as a function of the penetration depth by measuring the intensity decrease along a straight line at which the ballistic light travels through the photo-sensitive material, as well as the angular scattering intensity, and deriving therefrom a correction mask.

24. The method according to claim 23, wherein the obtained correction mask is applied onto a binary object derived from the three-dimensional object or article, and the optimized projected patterns are computed therefrom.

25. The method according to claim 19, wherein light from a second light source is focused by a lens and introduced into a resin container at a depth Z, so as to produce a slice of sensitized photosensitive material.

26. A device for performing the method according to claim 19, said device comprising a light source, a light modulator, a container for non-transparent and absorptive photo-sensitive material, and a side-view camera.

27. The device according to claim 26, further comprising a filter in an optical path between the container and the side-view camera.

28. The device according to claim 26, further comprising a second light source positioned orthogonally to a path of light patterns projected by said light modulator.

29. The device according to claim 28, further comprising a lens positioned orthogonally to the path of the light patterns projected by said light modulator, so as to produce at a depth Z a slice of sensitized photosensitive material.

30. A method of volumetric manufacturing a three-dimensional object or article by illuminating a photo-sensitive material with light patterns from multiple angles, said method comprising the step of projecting said light patterns onto the photo-sensitive material with a light modulator that is positioned off-center from a container containing said photo-sensitive material.

31. The method according to claim 30, wherein the container containing said photo-sensitive material is moved up and down, relative to the light modulator during the step of projecting said light patterns onto the photo-sensitive material.

32. A device for performing the method according to claim 30, said device comprising a light source, a light modulator, a container for photo-sensitive material, wherein said light modulator is positioned off-center from the container containing said photo-sensitive material.

33. The device according to claim 32, further comprising a transport device for moving the container for the photo-sensitive material up and down relative to the light modulator.

34. The device according to claim 32, wherein said container is arranged on a rotator, said rotator being connected to the transport device.

35. A method of volumetric manufacturing a three-dimensional object or article by illuminating a sample part with light patterns from multiple angles, said method comprising
a first step of projecting said light patterns onto the sample part with a light modulator, wherein a light dose delivered in this first step is below the gelation threshold of a resin provided in the sample part and evoking a single photon absorption process,
a second step of projecting light onto the sample part, wherein said light or said light patterns of said second step have a longer wavelength than said light patterns used in the first step and evoke a non-linear absorption process.

36. A device for performing the method according to claim 35, said device comprising a first light source, a second light source emitting light of a longer wavelength than the first light source, a first light modulator for projecting light patterns from said first light source, a second light modulator for projecting light patterns from said second light source, and a sample part for photo-sensitive material.
